(19) United States
(12) Patent Application Publication
(10) Pub. No.: US 2005/0049948 A1
(43) Pub. Date: Mar. 3, 2005

(54) Method for screening companies for investment

(75) Inventor: Richard M. Fuscone, Greenwich, CT (US)

Correspondence Address: DAVIDSON, DAVIDSON & KAPPEL, LLC, 485 SEVENTH AVENUE, 14TH FLOOR, NEW YORK, NY, 10018, US

(73) Assignee: CRF Research LLC, Greenwich, CT (US)

(21) Appl. No.: 10/650,230

(22) Filed: Aug. 28, 2003

(51) Int. Cl. G06F 17/60

(52) U.S. Cl. 705/35

(57) ABSTRACT

A method of screening companies for investment that includes the steps of identifying a plurality of candidate companies, obtaining philanthropy data relating to each of the plurality of companies, quantifying the philanthropy data for each of the plurality of companies according to at least one philanthropy parameter, and selecting at least two companies from the plurality of candidate companies based on the at least one philanthropy parameter so as to create a set of companies for investment.

### BACKGROUND OF THE INVENTION

The present invention relates to identifying companies for investment and particularly to a method for screening companies for investment based on one or more philanthropy parameters.

The complexity and unpredictability of securities markets has always made for difficulties in evaluating individual companies for investment. Recent events regarding corporate scandals and breaches of corporate governance in the United States have been a major source of concern for many investors and have served to only exacerbate the difficulty in evaluating companies. A lack of trust in the integrity and veracity of financial statements can have severe implications for the financial success of individual company's and for the economy as a whole.

It is known to select companies for investment according to a variety of investment criteria. For example, many funds select investment based upon macroeconomic, fundamental, or cyclical criteria. Additionally, some funds select companies using exclusionary practices, such as stock funds that purport to include only socially responsible companies. These funds typically employ exclusionary screening tools to eliminate companies from consideration that engage in one or more proscribed activities deemed unacceptable by investors or fund managers. For example, some funds exclude companies that are engaged in alcohol, tobacco, gambling, weaponry, pornography, or animal testing. These exclusionary screening methods, however, do not provide a method for selecting which companies to invest in, but rather selecting companies not to invest in.

At least one known stock index, in addition to employing exclusionary screens, purports to evaluate companies on a broad range of qualitative responsibility indicators. Companies determined to have a generally negative record across the range of indicators are excluded from consideration for inclusion on the index, whereas companies having a generally positive record across the range of indicators may be included in the index, if, for example, they are not excluded by the exclusionary criteria. A company's record on issues such as the environment, human rights, labor relations, employment equality, or community involvement, may be evaluated to determine whether to include or exclude the company in such a fund or index. A method that applies a broad range of qualitative indicators will necessarily depend on subjective judgment in determining whether to include or exclude a company for investment. Thus, the selection methods may be susceptible to individual prejudices and produce results that are not reliably reproducible.

### SUMMARY OF THE INVENTION

The inventor has reviewed historical philanthropic data and has determined that companies that demonstrate a commitment to significant charitable giving, in general, outperform composite benchmarks like the S & P 500. These companies have also tended to reflect more favorably in fundamental metrics, such as EBIT, EBITDA, operating cash flow, dividends, and free cash flow. Such companies tend to create workforce attitudes and environments that enable them to compete favorably as compared to other companies. Companies that have aligned their philanthropic efforts with the interests of their stakeholders (e.g. customers, employees, and shareholders) have tended to position themselves particularly well with respect to their competitors. Given the potential for enhanced returns, investors may be interested in identifying philanthropically minded companies for investment. In addition, investors may be interested in the identifying such philanthropically minded companies as a method of investing in a socially responsible manner.

An object of the present invention is to provide a method for identifying philanthropically minded companies for investment based upon specific quantitative philanthropic criteria, as well as providing a method for selecting companies for inclusion into a set of companies for investment. A further or alternate object is to provide a method that minimizes subjective judgment for the step of selecting of the companies.

The present invention provides a method of screening companies for investment that includes the steps of identifying a plurality of candidate companies, obtaining philanthropy data relating to each of the plurality of companies, quantifying the philanthropy data for each of the plurality of companies according to at least one philanthropy parameter, and selecting at least two companies from the plurality of candidate companies based on the at least one philanthropy parameter so as to create a set of companies for investment.

The at least one philanthropy parameter may include a first philanthropy parameter defined as a philanthropic contribution amount contributed by the respective company over a predetermined time period. The at least one philanthropy parameter may alternatively or additionally include a second philanthropy parameter defined as a ratio of the first philanthropy parameter to a performance indicator of the respective company during the predetermined time period. The performance indicator may be, for example, the earnings of the company during the period and is preferably net earnings before taxes of the company during the period. Alternatively, the at least one philanthropy parameter may be only a single philanthropy parameter, and the selecting may be performed based solely on the single philanthropy parameter.

The method may also include the step of selecting at least one security associated with each of the companies in the set of companies for investment so as to create a corporate responsibility fund benchmark. A benchmark value may also be calculated for the benchmark by taking a relative percentage of the market value of each security in the benchmark. The benchmark value is preferably tracked over time to obtain historical benchmark value information and may be compared to a known benchmark of securities, such as the S&P 500® Index, the Dow Jones Industrial Average®, and the NASDAQ Composite® Index.

An industry sector indicator may also be assigned to each of the plurality of candidate companies, and the selecting may be based on the at least one philanthropy parameter and on the industry sector indicator of each of the candidate companies. Alternatively, the method may include assigning an industry sector indicator after the selecting step to each of the companies selected for investment.

In addition, weighting factors may be assigned to different philanthropy parameters and the selecting may take into account the weighting factors. The method may also include ranking the companies in the set of companies according to the at least one philanthropy parameter, and the selecting may include selecting at least two companies according to the ranking.

The present invention also provides a method for creating a corporate responsibility fund benchmark of securities. The method includes the steps of identifying a first set of companies, each of the companies being associated with a security. The method also includes obtaining philanthropy data for each of the companies in the set and quantifying the philanthropy data according to at least one philanthropy parameter. A plurality of companies is then selected from the first set of companies based on the at least one philanthropy parameter so as to create a second set of selected companies, and a corporate responsibility fund benchmark is then created including at least one security of each of the candidate companies.

A benchmark value may be calculated based on a price of each security in the benchmark. The calculating may involve a relative percentage of the market value of each security in the benchmark. The benchmark is preferably tracked over time, and may be compared with any of a number of known securities benchmarks.

In addition, the present invention provides a method for creating a corporate responsibility fund set of securities that includes the steps of identifying a first set of securities, assigning a first philanthropy score to each company in the first set, assigning a second philanthropy score to each company in the first set, and selecting at least two companies based on the first and second philanthropy scores so as to create a second set of companies for investment. At least one security of each of the companies in the second set is then selected for inclusion in the corporate responsibility fund set of securities.

Preferably, the philanthropy score for each security is a function of a philanthropy contribution amount contributed by the respective company over a predetermined time period and/or a function of a ratio of the annual philanthropy contribution amount contributed by the respective company over a predetermined time period to a performance indicator of the respective company during the predetermined time period. The performance indicator may include a financial metric, such as pretax net earnings, EBITDA, or free cash flow of the company.

At least some of the steps of the methods provided by the present invention may be performed using a general process computer. The present invention also provides a computer readable medium having stored thereon computer executable process steps operative to perform a method for selecting a set of securities for investment. The process steps include receiving a list of a first set of companies, receiving a first philanthropy score corresponding to each of the companies in the first set, and receiving a second philanthropy score corresponding to each of the companies in the first set. The process steps also include comparing the first philanthropy score for each of the companies in the first set to a first threshold score, comparing the second philanthropy score for each of the companies in the first set to a second threshold score, and selecting a company for inclusion in the set of companies for investment when either the first philanthropy score for the company exceeds the first threshold score or the second philanthropy score for the company exceeds the second threshold score.

### BRIEF DESCRIPTION OF THE DRAWINGS

The following figures show a preferred embodiment of the present invention in which:

FIG. 1 shows a schematic diagram of a method of screening companies for investment according to the present invention;

FIG. 2 shows a chart of philanthropy-related data for six candidate companies to be evaluated according to the exemplary embodiment of the present invention; and

FIG. 3 shows a chart of scores assigned to the companies in FIG. 2 relating to several philanthropic parameters.

### DETAILED DESCRIPTION

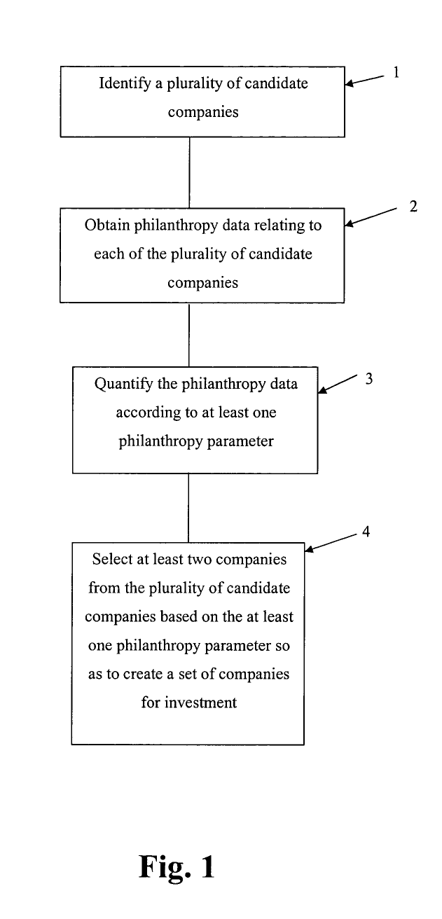

FIG. 1 shows, in schematic form, a preferred method of screening companies for investment according to the present invention. In step 1, a plurality of candidate companies is identified. The plurality of candidate companies may be identified as any set of candidate companies thought to be useful for screening. One useful example of a set of candidate companies are those companies that are included in a known stock index or benchmark (such as the S&P 500® Index, the Dow Jones Industrial Average®, the NASDAQ Composite® Index, etc.). The set of candidate companies may also include the companies within an existing portfolio, an existing mutual fund, a chosen industry sector, or any other useful set of companies.

In step 2, philanthropy data relating to each company in the set of candidate companies is obtained. Philanthropy data may include any information relating to the company's commitment to philanthropy. Such information may include the amount of cash and non-cash contributions allocated for or contributed to philanthropic purposes over a given period of time. The amount may be expressed as a lump-sum amount, or as a ratio, such as a percentage of the company's net earnings before taxes or EBITDA for the period of time the contributions were made or allocated. Philanthropy data may also include information about a company's internal policies that demonstrate a commitment to philanthropy. For example, a policy encouraging a company's employees to join its philanthropic efforts, or the existence of incentives such as matching funds for certain employee charitable contributions may be relevant. Philanthropy data may also include information about methods of giving employed by the company, such as through direct contributions to particular causes or through foundations. Historical information about a company's past philanthropic efforts may also be included, such as the length of time that the company has been philanthropically-minded, consistency of the giving over time, devotion to particular causes or institutions, and partnerships with one or more foundations. Information relating to the beneficiaries or categories of philanthropic causes may also form part of the philanthropic data.

The philanthropy data may be obtained in a number of ways. Relevant information may be publicized by the company, for example in newspapers, press releases, trade publications, on the company's website. Such information may also be gathered from earnings statements or other public securities filings of the company. Recipients of the company's philanthropy or organizations that track charitable and philanthropic giving may also be a source for obtaining philanthropy data. If a company is associated with a charitable foundation, information relating to the philanthropic efforts of the foundation may be available from the foundation. In addition, relevant information may also be obtained by direct contact with representatives of the company.

In step 3 of FIG. 1, the philanthropy data is quantified according to at least one philanthropy parameter. As used herein, a philanthropy parameter is a specific quantitative measure of a company's commitment to philanthropy. For example, a philanthropy parameter may be an annual philanthropic contribution amount of each candidate company for a specific year. In that case, quantifying the philanthropy data would include selecting the philanthropy data obtained that is relevant to the annual philanthropic amount for that year. If contribution amount includes both cash contributions and in-kind contributions, the quantification of the information may include estimating or utilizing an assigned value for such in-kind contributions for each candidate company. Another example of a philanthropy parameter may be a ratio of a philanthropic contribution amount during a particular period to a performance indicator of the company. The performance indicator may be a measure of revenues or earnings, such as net earnings before taxes (“NEBT”) or EBITDA during the period. The period may include one or more years for which philanthropy data was obtained, or may include smaller or larger time increments.

Other philanthropy parameters may also be quantified. If the philanthropic data obtained is of a qualitative nature, the step of quantifying may include assigning a numerical score corresponding to the qualitative information obtained in the previous step. For example, if a philanthropy parameter includes the philanthropic causes or beneficiaries of the company's philanthropic efforts, a score may be assigned according to various categories of causes or beneficiaries. For example, philanthropic efforts directed toward improvement of community health may be given a higher score than those directed toward religious instruction, or vice versa. Alternatively, the score may take into account the relationship between the philanthropic causes and the nature of the companies business. The scoring may be assigned based on a ranking of the candidate companies relative to one another, or may be assigned based on a predetermined objective scale. Other qualitative philanthropic data that may be quantified in this manner may include, for example, the method of giving (e.g., directly to certain causes or through foundations), a consistency of giving over time, the length of time the company has been philanthropic-minded, the devotion to particular causes or institutions, or the existence of a partnership with one or more foundations. In addition, information relating to each company's internal policies and attitudes towards philanthropy may be quantified according to a further philanthropy parameter. For example, the existence of programs or incentives philosophy may be evaluated and a score assigned.

In step 4, at least two companies are selected from the plurality of candidate companies based on the at least one philanthropy parameter so as to create a set of companies for investment. Thus, for example, if the philanthropy parameter is an annual philanthropic contribution amount for a particular year, companies may be selected in this step that have an annual philanthropic contribution amount that exceeds a certain threshold amount. Alternatively, the selection may be made by comparing relative values of the companies within the philanthropy parameter and choosing a predetermined number of companies that score best. Thus, for example, one may choose the top twenty companies based on their annual philanthropic contribution amounts, or one may choose all those companies having an annual philanthropic contribution amount over a certain threshold contribution amount.

Preferably, a company is selected when either one or both of two philanthropy parameters exceeds a certain threshold value for that philanthropy parameter. In one embodiment, the philanthropy data is quantified into a first philanthropy parameter representing an aggregate philanthropy contribution amount for the company over a certain time period. The philanthropy data is also quantified into a second philanthropy parameter representing a relative contribution amount expressed as a ratio of the aggregate philanthropy contribution amount for a company to a performance indicator for the company (e.g. NEBT or EBITDA) over the same period. If the first philanthropy parameter of a company exceeds a first threshold amount, or the second philanthropy parameter of a company exceeds a second threshold ratio, then the company is selected for inclusion in the set of companies for investment.

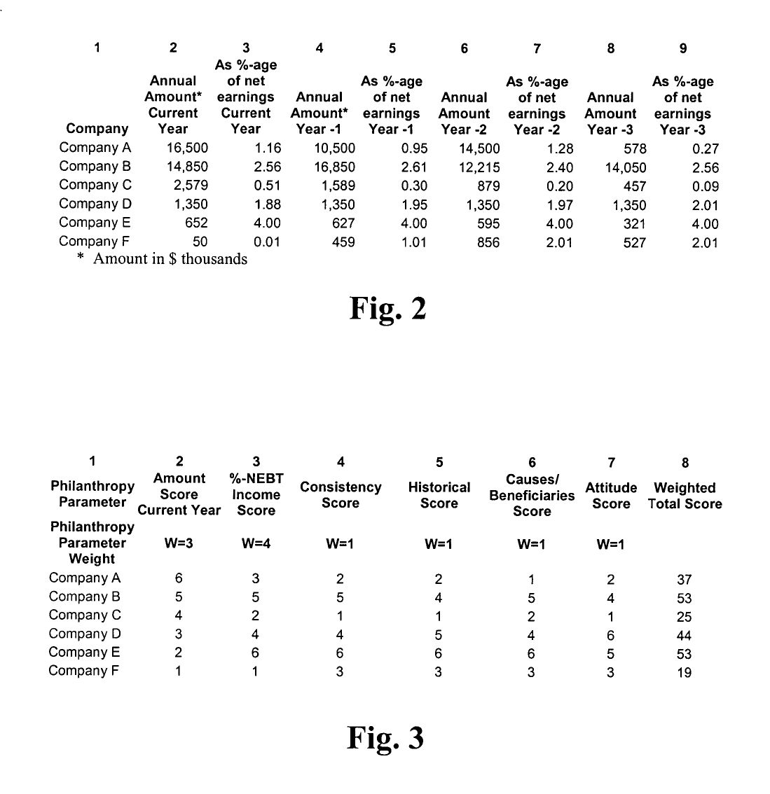

FIG. 2 shows an example of some philanthropy-related data that was obtained and quantified according to several philanthropy parameters for six candidate companies listed in column 1 of the table. Company A, Company B, Company C, Company D, Company E, and Company F. Column 2 of the table shows the annual philanthropic contribution amount (expressed in thousands of dollars) for each company. The figures represent the total amount of in-kind and cash charitable contributions made by the company in the most current year for which data was obtained. Alternatively, data could be obtained and quantified that represents a forward projection of planned contributions for the coming year, or a mixture between planned and actual contributions. For illustration purposes, the number of candidate companies illustrated is relatively small. Although not necessary, identification of a larger number of candidate companies in the first step is generally preferable for obtaining more meaningful results.

Column 3 of FIG. 2 shows the annual philanthropic contribution for each company expressed as a percentage of NEBT for each company for the current year. Column 4 shows the annual philanthropic contribution amount (in thousands of dollars) for each of the companies in the year prior to the current year (Year-1). Column 5 shows the contribution in Year-1 in terms of a percentage of net earnings before taxes. Note that because the net earnings of the companies changes from year to year, a decrease in contribution amount from one year to the next may or may not correspond to a decrease in the contribution as a percentage of net income. Columns 6 and 7 show philanthropic contributions of the companies in amount and as a percentage of net income in Year-2 (two years prior to the current year). Columns 8 and 9 show philanthropic contributions of the companies in amount and as a percentage of net income in Year-3 (three years prior to the current year).

FIG. 3 shows a chart showing scores that have been assigned for various philanthropy parameters assigned to each of the companies in FIG. 2. The scores assigned to the companies shown in FIG. 3 are relative scores corresponding to a ranking of the companies relative to one another (with 6 representing the highest ranking score and 1 representing the lowest ranking score) in each philanthropy parameter. Alternatively, an objective scaled scoring system could be used (for example 1-100) based upon predetermined targets for each philanthropy parameter instead of a comparative ranking of the evaluated companies. A further alternative is to use a raw score scoring system where the philanthropy data can be quantified as a raw number. For example a dollar amount representing the annual philanthropic contribution amount could serve as the raw score without assigning a further ranking score or scaled score to the raw dollar amount.

The philanthropy parameters shown in FIG. 3 include current year philanthropic contribution amount (column 2), philanthropic amount as a percentage of net income before taxes (“NEBT”) (column 3), consistency of giving (column 4), history of the company's philanthropy (column 5), the causes or beneficiaries of the company's philanthropy (column 6), and the company's internal attitude towards philanthropy (column 7). The scores in columns 2, 3, and 4 were derived directly from the data in FIG. 2. The scores in columns 5, 6, and 7 rely on additional philanthropy data collected about the companies.

Column 2 of FIG. 3 shows the scores assigned to the companies based on the philanthropic contributions made or allocated in the current year (the data in column 2 of FIG. 2). Column 3 shows scores assigned based on contributions as a percentage of net income before taxes in over the most recent three-year period (the data in columns 3, 5, and 7 of FIG. 2). The consistency score (column 4) is based upon the historical data shown in FIG. 2, specifically columns 3, 5, 7, and 9. For the consistency score (or ranking), companies that have shown consistently high contributions as a percentage of net income were ranked higher than companies that were less consistent or that were consistently lower in their philanthropic contributions when measured as a percentage of pre-tax net earnings. Thus, for example, Company F ranked higher than Company A in consistency, even though its contributions for the current year were significantly less. The higher ranking reflects the recent historical data showing a more consistent effort by Company F toward philanthropy than by Company A measured as a proportion to pre-tax net income.

The score relating to a history of a company's philanthropy (column 5) is similar to the score for the consistency criterion, but may cover a longer period and may include additional factors such as the total length of time a company has been philanthropic-minded, the devotion to particular causes or institutions, and an existence and length of a relationship with one or more foundations. Thus, for example, Company D scored better than Company C in this category, even though the data in FIG. 2 for recent historical contributions were higher for company B. The higher ranking for Company D may reflect a significantly longer demonstrated commitment to philanthropy or a commitment that differs qualitatively from that demonstrated by Company B.

The score in column 6 of FIG. 3 represents a quantification of philanthropic efforts of the companies based on the causes or beneficiaries of the company's philanthropy. In order to determine this score, the company's contributions may be broken down into categories of beneficiaries. For example, efforts aimed at improving the local community may be valued differently than national or international community improvement efforts.

The score relating to the company's internal attitude toward philanthropy (column 7) may be based on the existence of programs or incentives at a company, through which employees of various levels can participate in the company's philanthropic philosophy. Again, scores may be assigned by rating the existence, extent, and/or perceived effectiveness of such internal policies.

The weighted total score in column 8 of FIG. 3 were determined by assigning a weighting factor to each of the philanthropy parameters according to a perceived importance or value of those parameters. In this embodiment, the contribution amount was assigned a weighting factor of 3, the contribution as a percentage of NEBT was assigned a weighting factor of 4, and the other philanthropy parameters were assigned a weighting factor of 1. Column 8 represents a weighted total score, and the values were calculated by multiplying the value of the other philanthropy parameters by the weighting factor, and adding them together.

Two or more of the companies may be selected from the companies listed in FIG. 3 based on one or more of the philanthropy parameters illustrated in columns 2-8. For example, a selection of the top two companies based upon the philanthropy parameter of annual philanthropic amount in the current year, would result in Company A and Company B being selected for investment. A selection of the top two companies using annual philanthropic contribution as a percentage of NEBT would result in Company B and Company E being selected for investment. If the total weighted score were used as the philanthropy criterion, Company B and Company E would be the first two companies selected. Of course, if a scaled score or lump sum dollar amount is used for the philanthropy parameters instead of ranking, the selection may be made of all those companies that satisfy a predetermined minimum criterion (such as a minimal score or minimal dollar amount in one or more philanthropy parameters) instead of selecting a predetermined number of companies.

Once the set of companies for investment is selected, the set may be used for a number of useful purposes. An investor may use an investment strategy of investing in some or all of the companies selected from the list, for example, by purchasing at least one security from each of the companies in the set. In addition, a number of fund products may be created to make use of the set of companies for investment, and/or a benchmark may be created that includes at least one security from each of the companies in the set, referred to herein as a corporate responsibility fund (“CRF”) benchmark.

For example, a traditional mutual fund may be created in which the mutual fund manager is restricted to investing all or a portion of the fund in securities of companies, typically shares of common stock, selected from those companies in the set. Alternatively, a fixed income fund could be set up in which the fund manager is restricted to investing all or a portion of the fund in fixed income securities (e.g. bonds) of companies selected from those companies in the set.

Alternative investment funds may also be set up using the set of companies selected in step 4. For example, a alternative investment fund could be created in which the fund manager plans to takes long and short equity positions using the fund, and in which the fund manager may be restricted to taking only long positions in companies from the set. Additional alternative investment related funds may be created that use the set of companies selected in step 4 of FIG. 1, and which also employ known investment strategies. Some examples of these include: Equity Market Neutral—exploiting equity market inefficiencies and usually involves matched simultaneous long and short equity portfolios of the same size within a country; Dedicated Short Bias—investing in short positions in equity and equity derivative products; Managed Futures—investing in listed financial and commodity futures markets and currency markets around the world; Principle Protection—providing a guarantee on principle invested or on a percentage of principle invested over a set term; Convertible Arbitrage—involving hedged investing in convertible securities of a company; Event Driven—involving investing designed to capture price movement generated by a significant pending corporate event such as a merger, corporate restructuring, liquidation, bankruptcy or reorganization; Fixed Income Arbitrage—aiming to profit from price anomalies between related interest rate securities; and Global Macro—involving carrying long and short positions in any of the world's major capital or derivative markets.

As mentioned above, at least one security of each of the companies in the set of companies for investment could be selected for inclusion in a CRF benchmark. A benchmark value for the CRF benchmark may be calculated, for example, by taking a sum of the security prices of each of the securities included in the benchmark and dividing the sum by the number of securities in the benchmark.

The value of the CRF benchmark could then be tracked over time, either continuously or at regular intervals. The value of the benchmark could also be compared with other known equity performance indices such as, for example, the S &P 500® Index, the Dow Jones Industrial Average®, the NASDAQ Composite® Index, or any other equities index or benchmark, to provide an indication of the relative performance of the companies in the CRF benchmark.

Preferably, the number of companies selected for inclusion in the CRF benchmark is sufficiently large so as to be broken down into industry sector categories. Thus, each of the companies in the benchmark can be assigned an industry sector. The assignment of companies to industry sectors may also be made to the candidate companies before the selection is made, and the selection of companies may also take into account the industry sector assignment of the candidate companies in an effort to achieve a set of companies having a relatively balanced representation a number of industry sectors. The industry sector assignments may be made, for example, using one or more industry sectors listed in the Standard Industry Classification (“SIC”) that is put out by the Department of Labor, or any other set of industry sectors. The number of securities for each company selected for inclusion in the benchmark may depend, in part, upon the industry sector assignment. The CRF benchmark may also be broken down according to industry segment assignments and each industry sector in the CRF may also be tracked against industry sectors from known stock benchmarks.

It is, of course, contemplated that steps of the method would be carried out repeatedly over time so as to reflect changed circumstances of the companies over time. As time passes, new philanthropy data may be obtained so as to achieve the most current information and status. A selection performed on updated data or according to an updated configuration of philanthropy parameters may yield a different set of companies than the set of companies selected in a previous application of the method. There may be a desire to periodically reevaluate and/or change the makeup of companies or the number of securities from each company included in the benchmark from time to time. This may be done at regular and infrequent intervals, such as once a year, or more or less frequently as dictated by the circumstances.

In the following, a method according to the present invention will be described with reference to a particular example.

### EXAMPLE

A plurality of candidate companies was identified as including the 500 companies included in the S&P 500® Index. Philanthropy data relating to each of the companies in the S&P 500® Index was then obtained for fiscal years 1999 through 2001. As stated above, the step of obtaining data included researching each company for information relating to the company's philanthropic efforts from any number of a variety of sources. Obtaining the data included verifying data from one source with data obtained by another source and reconciling conflicting data from a number of sources to come up with the most reliable philanthropy data. The philanthropy data was quantified according to several philanthropy parameters. Specifically, the aggregate philanthropy contribution for each company was quantified for each of the fiscal years 1999-2001. The annual philanthropy contribution amount included both cash and in-kind contributions. In addition, a relative philanthropy contribution was quantified as a ratio of the aggregate philanthropy contribution amount to a percentage of (NEBT) for each year, and for the three-year period 1999-2001.

Companies were then selected to create a set of companies for investment based upon the two philanthropy parameters. Companies were selected from the candidate companies from the S&P 500® Index if the annual philanthropic contribution amount in the most current year available exceeded a threshold amount in the most current year (fiscal year 2001). In addition, companies were selected if the philanthropic contribution amount for that company exceeded a certain threshold percentage of net earnings for the three most current years (fiscal years 1999-2001). Based on these criteria, 65 companies were selected: 23 companies were selected because their annual philanthropy contribution amount exceeded the threshold amount, and 42 companies were chosen because their philanthropy contribution exceeded the threshold percentage.

A CRF benchmark was then created using by selecting at least one share of common stock for each of the 65 selected companies. A benchmark value of the CRF benchmark was then calculated taking a relative percentage of the market value of each security in the benchmark. The value of the CRF benchmark was then tracked over a period of time using historical stock prices to measure the historical performance of the CRF benchmark. In addition, the historical performance of the CRF benchmark was compared with the performance of the S&P 500® Index over time.

Industry sectors were assigned to the companies selected as follows: autos and transportation; consumer discretionary; consumer staples; financial services; health care; integrated oils; materials and processing; other energy; producer durables; technology; utilities; and other. Performance of the companies in the benchmark was also tracked according to the industry sectors.

The present invention has been described herein with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

1. A method of screening companies for investment, the method comprising:
identifying a plurality of candidate companies;
obtaining philanthropy data relating to each of the plurality of companies;
quantifying the philanthropy data for each of the plurality of companies according to at least one philanthropy parameter; and
selecting at least two companies from the plurality of candidate companies based on the at least one philanthropy parameter so as to create a set of companies for investment.

2. The method as recited in claim 1 wherein the at least one philanthropy parameter is a single philanthropy parameter and wherein the selecting is performed based solely on the single philanthropy parameter.

3. The method as recited in claim 1 further comprising purchasing at least one security associated with each of the companies in the set of companies for investment.

4. The method as recited in claim 1 further comprising selecting at least one security associated with each of the companies in the set of companies for investment for inclusion in a corporate responsibility fund benchmark.

5. The method as recited in claim 4 further comprising calculating a benchmark value for the corporate responsibility fund benchmark by taking a relative percentage of a market value of each security in the benchmark.

6. The method as recited in claim 5 further comprising tracking the benchmark value over time so as to obtain historical benchmark value information.

7. The method as recited in claim 6 further comprising comparing the benchmark value to a second benchmark of securities.

8. The method as recited in claim 7 wherein the second benchmark of securities is selected from the group consisting of the S&P 500® Index, the Dow Jones Industrial Average®, and the NASDAQ Composite® Index.

9. The method as recited in claim 1 wherein the at least one philanthropy parameter includes a first philanthropy parameter defined as a philanthropic contribution amount contributed by the respective candidate company over a predetermined time period.

10. The method as recited in claim 9 wherein the predetermined time period is one of a single year, two years, or three years.

11. The method as recited in claim 10 wherein the selecting includes selecting at least two companies having a philanthropic contribution amount greater than a threshold contribution amount.

12. The method as recited in claim 9 wherein the at least one philanthropy parameter includes a second philanthropy parameter defined as a ratio of the first philanthropic parameter to a performance indicator of the respective candidate company over the predetermined time period.

13. The method as recited in claim 12 wherein the performance indicator includes a net earnings before taxes of the respective candidate company during the predetermined time period.

14. The method as recited in claim 13 wherein the predetermined time period is a recent 3-year period.

15. The method as recited in claim 12 wherein the selecting includes selecting at least two companies having a second philanthropy parameter greater than a predetermined ratio.

16. The method as recited in claim 1 further comprising assigning an industry sector indicator to each of the plurality of candidate companies, and wherein the selecting is based on the at least one philanthropy parameter and on the industry sector indicator of each of the candidate companies.

17. The method as recited in claim 1 further comprising ranking the companies in the set of companies according to the at least one philanthropy parameter.

18. The method as recited in claim 17 wherein the selecting includes selecting the at least two companies according to the ranking.

19. The method as recited in claim 1 wherein the at least one philanthropy parameter includes a first philanthropy parameter and a second philanthropy parameter and further comprising assigning a first weighting factor to the first philanthropy parameter and a second weighting factor to the second philanthropy parameter, and wherein the selecting is performed taking into account the first and second weighting factors.

20. A method for creating a corporate responsibility fund benchmark of securities, the method comprising:
identifying a first set of companies, each of the companies associated with a security;
obtaining philanthropy data for each of the companies;
quantifying the philanthropy data according to at least one philanthropy parameter;
selecting a plurality of companies from the first set of companies based on the at least one philanthropy parameter so as to create a second set of selected companies; and
creating a corporate responsibility fund benchmark including at least one security of each of the companies in the second set of selected companies.

21. The method as recited in claim 20 further comprising calculating a benchmark value based on a price of each security in the benchmark.

22. The method as recited in claim 21 wherein the calculating includes taking a relative percentage of a market value of each security in the benchmark.

23. The method as recited in claim 21 further comprising tracking the benchmark value over time.

24. The method as recited in claim 21 further comprising comparing the benchmark value with a value of a second benchmark of securities.

25. A method for creating a corporate responsibility fund set of securities, the method comprising:
identifying a first set of companies, each of the companies associated with a security;
assigning a first philanthropy score to each company in the first set;
assigning a second philanthropy score to each company in the first set;
selecting a at least two companies based on the first and second philanthropy scores so as to create a second set of companies for investment; and
selecting at least one security from each of the companies in the second set for inclusion into the corporate responsibility fund set of securities.

26. The method as recited in claim 25 wherein the selecting includes selecting at least two securities when the first philanthropy score exceeds a first threshold score or the second philanthropy score exceeds a second threshold score.

27. The method as recited in claim 25 wherein the first philanthropy score is a function of a philanthropy contribution amount contributed by the respective company over a predetermined time period.

28. The method as recited in claim 27 wherein the second philanthropy score is a function of a ratio of the first philanthropy score to a performance indicator the respective company during the predetermined time period.

29. The method as recited in claim 28 wherein the performance indicator is a pre-tax net earnings.

30. A computer readable medium having stored thereon computer executable process steps operative to perform a method for selecting a set of securities for investment, the process steps comprising:
receiving a list of a first set of companies;
receiving a first philanthropy score corresponding to each of the companies in the first set;
receiving a second philanthropy score corresponding to each of the companies in the first set;
comparing the first philanthropy score for each of the companies in the first set to a first threshold score;
comparing the second philanthropy score for each of the companies in the first set to a second threshold score; and
selecting a company for inclusion in the set of companies for investment when either the first philanthropy score for the company exceeds the first threshold score or the second philanthropy score for the company exceeds the second threshold score.

31. The computer readable medium as recited in claim 30 wherein the first philanthropy score is a philanthropic contribution amount contributed by the respective company during a predetermined time period.

32. The computer readable medium as recited in claim 31 wherein the second philanthropy score is a ratio of the first philanthropy score to a performance indicator of the respective company during the predetermined time period.
